(19) United States
(12) Patent Application Publication
(10) Pub. No.: US 2017/0277650 A1
(43) Pub. Date: Sep. 28, 2017

(54) User equipment and method for data transmission

(71) Applicants: LE HOLDINGS (BEIJING) CO., LTD., Beijing (CN); LEMOBILE INFORMATION TECHNOLOGY (BEIJING) CO., LTD., Beijing (CN)

(72) Inventors: Qing ZHAO, Beijing (CN); Wei WANG, Beijing (CN)

(21) Appl. No.: 15/240,163

(22) Filed: Aug. 18, 2016

Related U.S. Application Data
(63) Continuation of application No. PCT/CN2016/088660, filed on Jul. 5, 2016.

(30) Foreign Application Priority Data
Mar. 25, 2016 (CN) 2016101770633

(51) Int. Cl. G06F 13/42; G06F 13/40; G06F 13/38

(52) U.S. Cl. CPC G06F 13/4282; G06F 13/385; G06F 13/4022

(57) ABSTRACT

Embodiments of the disclosure disclose user equipment and a method for data transmission, and the user equipment includes: a USB Type-C interface, a USB physical layer, an audio codec and an analog switch device. A left channel terminal and a right channel terminal of the audio codec and a data transmission terminal of the USB physical layer multiplex D+ and D− pins of the USB Type-C interface. The first analog switch device is configured to, when detecting that an analog audio cable is inserted into the USB Type-C interface, switch the D+ and D− pins of the USB Type-C interface to connect the left channel terminal and the right channel terminal of the audio codec, respectively.

### CROSS REFERENCE TO RELATED APPLICATIONS

The present application is a continuation of PCT application which has an application number of PCT/CN2016/088660 and was filed on Jul. 5, 2016. The present application claims the priority of Chinese patent application No. 201610177063.3, entitled “User Equipment”, filed with the State Intellectual Property Office of the People's Republic of China on Mar. 25, 2016, which is incorporated herein by reference in its entirety.

### TECHNICAL FIELD

Embodiments of the disclosure relate to the field of electronic technology, particularly to user equipment with a USB TYPE-C interface and a method for data transmission, and besides being useful for a USB data transmission, the USB TYPE-C interface can also be compatible with an audio transmission of an analog headphone.

### BACKGROUND

Computers have gained popularity, which fully influences people's daily lives. They have plentiful interfaces: a serial port, a parallel port, a HDMI, a SATA and the like, wherein the most widely used is a universal serial bus interface, commonly called USB. It can not only connect storage equipment, but also serve as a universal expansion interface. As technology advances, the speed of a USB interface becomes faster and faster, and the USB interface can be compatible with more and more equipments. Meanwhile, the shape of the USB interface is also going through changes, from TYPE A to MINI then to MICRO B. Today, the most popular USB shape is TYPE-C. It not only has a fast speed and transmits a large current, but also supports a reciprocal plug. It is convenient and easy to use.

In the process of realizing this disclosure, the inventor finds that there are at least the following issues in related technologies: today, there are a USB digital interface and an analogue headphone interface on a phone typically. FIG. 1 shows a structure diagram of a headphone plug provided by the prior art. FIG. 2 shows a structure diagram of a headphone socket provided by the prior art. As shown in FIGS. 1 and 2, the diameter of the headphone plug is typically 3.5 mm, and since the headphone plug needs to be entirely covered by the headphone socket, the thickness of the headphone socket cannot be less than 3.5 mm, which means that the existing headphone socket must occupy a certain printed circuit board (PCB) space of the phone, and which is one reason why the phone cannot be thinner.

### SUMMARY

In view of this, the purpose of the embodiments of the disclosure is to provide a new analog audio transmission scheme to overcome the aforesaid deficiencies in the prior art, so that the user equipment can be designed more portable.

The embodiments according to the disclosure provide user equipment, which includes: a USB Type-C interface, which is compatible with USB signal delivery and analog audio peripherals; a USB physical layer, which is configured to connect with the USB Type-C interface to realize the transmission of a USB signal; an audio codec, which is configured to connect with the USB Type-C interface to realize the transmission of an analog audio, wherein a left channel terminal and a right channel terminal of the audio codec and a data transmission terminal of the USB physical layer multiplex D+ and D− pins of the USB Type-C interface; and a first analog switch device, which is configured to achieve the multiplexing. The first analog switch device is configured to, when detecting that an analog audio cable is inserted into the USB Type-C interface, switch the D+ and D− pins of the USB Type-C interface to connect with the left channel terminal and the right channel terminal of the audio codec respectively, and is configured to, when detecting that a USB cable is inserted into the USB Type-C interface, switch the D+ and D− pins of the USB Type-C interface to connect with the data transmission terminal of the USB physical layer respectively.

In one embodiment, the first analog switch device or the second analog switch device is configured to judge the type of the cable inserted into the USB Type-C interface by detecting a resistance value of a CC1 pin and/or CC2 pin of the USB Type-C interface.

Further, the first analog switch device is configured to determine that an analog audio cable is inserted into the USB Type-C interface, when detecting that the resistance value between the CC1 pin and a GND pin and the resistance value between the CC2 pin and the GND pin are both less than 1 kΩ.

In one embodiment, the user equipment further includes the second analog switch device, which is configured to achieve the microphone data transmission of the audio codec by utilizing a SBU1 pin or a SBU2 pin of the USB Type-C interface.

Further, the second analog switch device is configured to judge whether the analog audio cable inserted into the USB Type-C interface supports a microphone by detecting the resistance value of the SBU1 pin or the SBU2 pin of the USB Type-C interface.

In one embodiment, the user equipment can be a smart phone, a portable computer, a tablet computer, a desktop computer or other appropriate user equipments having the USB Type-C interface and supporting an analog audio output.

Another embodiment of the present disclosure provides a method for data transmission, which is applied to the user equipment, the method including: judging the type of the cable inserted into the USB Type-C interface of the user equipment, when detecting that an analog audio cable is inserted into the USB Type-C interface, switch the D+ and D− pins of the USB Type-C interface to connect with the left channel terminal and the right channel terminal of the audio codec respectively, and when detecting that a USB cable is inserted into the USB Type-C interface, switch the D+ and D− pins of the USB Type-C interface to connect with the data transmission terminal of the USB physical layer respectively; wherein the USB Type-C interface is compatible with USB signal delivery and analog audio peripherals; the USB physical layer is connected with the USB Type-C interface to realize the transmission of a USB signal; the audio codec is connected with the USB Type-C interface to realize the transmission of an analog audio.

In one embodiment, judging the type of the cable inserted into the USB Type-C interface of the user equipment, includes: judge the type of the cable inserted into the USB Type-C interface by detecting a resistance value of a CC1 pin and/or CC2 pin of the USB Type-C interface.

In one embodiment, judging the type of the cable inserted into the USB Type-C interface of the user equipment, includes: determine that an analog audio cable is inserted into the USB Type-C interface, when detecting that the resistance value between the CC1 pin and a GND pin of the USB Type-C interface and the resistance value between the CC2 pin and the GND pin of the USB Type-C interface are both less than 1 kΩ.

In one embodiment, the method further includes: achieve the microphone data transmission of the audio codec by utilizing a SBU1 pin or a SBU2 pin of the USB Type-C interface.

In one embodiment, the method further includes: judge whether the analog audio cable inserted into the USB Type-C interface supports a microphone by detecting the resistance value of the SBU1 pin or the SBU2 pin of the USB Type-C interface.

According to embodiments of the disclosure, the USB Type-C interface can be directly used to achieve an analog audio transmission function, thus a traditional analog audio outlet, such as a 3.5 mm audio outlet, can be omitted. Further, the printed circuit board space of the user equipment may be further saved, thus the user equipment may be manufactured to be more portable.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 shows a structure diagram of a headphone plug provided by the prior art;

FIG. 2 shows a structure diagram of a headphone socket provided by the prior art;

FIG. 3 shows an allocating schematic view of socket pins in accordance with the USB Type-C specification;

FIG. 4 shows a principle schematic view of the user equipment in accordance with one embodiment of the disclosure.

FIG. 5 shows a diagram of the method for data transmission in accordance with one embodiment of the disclosure.

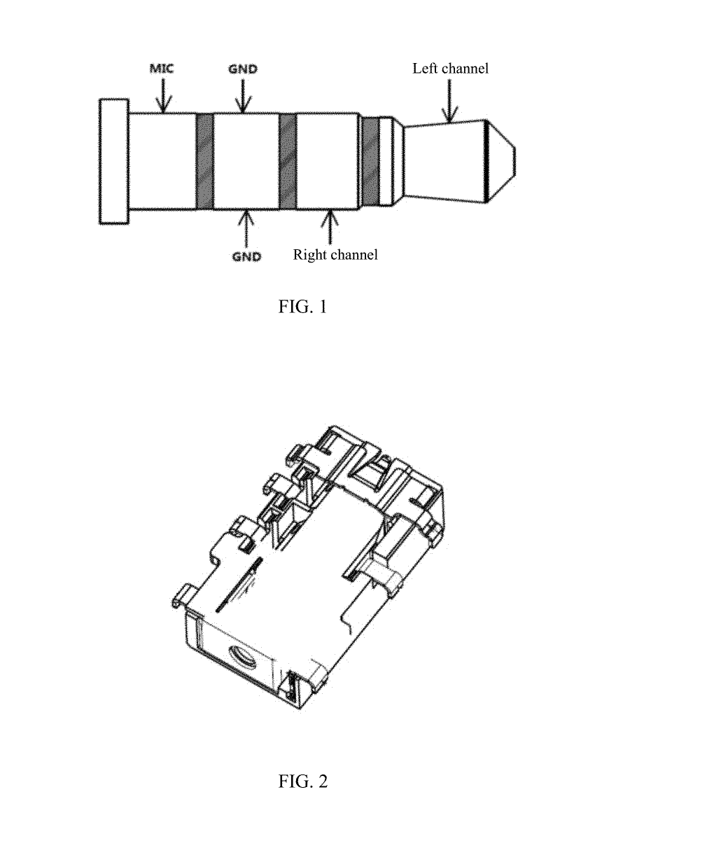

Part of the reference numerals and meanings thereof are as follows:
GND: Grounding
MIC: Microphone
USB PHY: USB physical layer
CODEC: Codec
MICBIAS: Microphone biasing
L: Left channel
R: Right channel
SW1: First analog switch device
SW2: Second analog switch device

### DETAILED DESCRIPTION

The exemplary embodiments of the present disclosure will be described in more detail hereinafter with reference to the accompanying figures. Although the exemplary embodiments of the present disclosure are shown in the accompanying figures, it should be understood that the present disclosure can be embodied in various forms, and should not be limited by embodiments set forth herein. Conversely, these embodiments are provided so that the disclosure will be better understood, and the scope of the present disclosure will be fully conveyed to those skilled in the art.

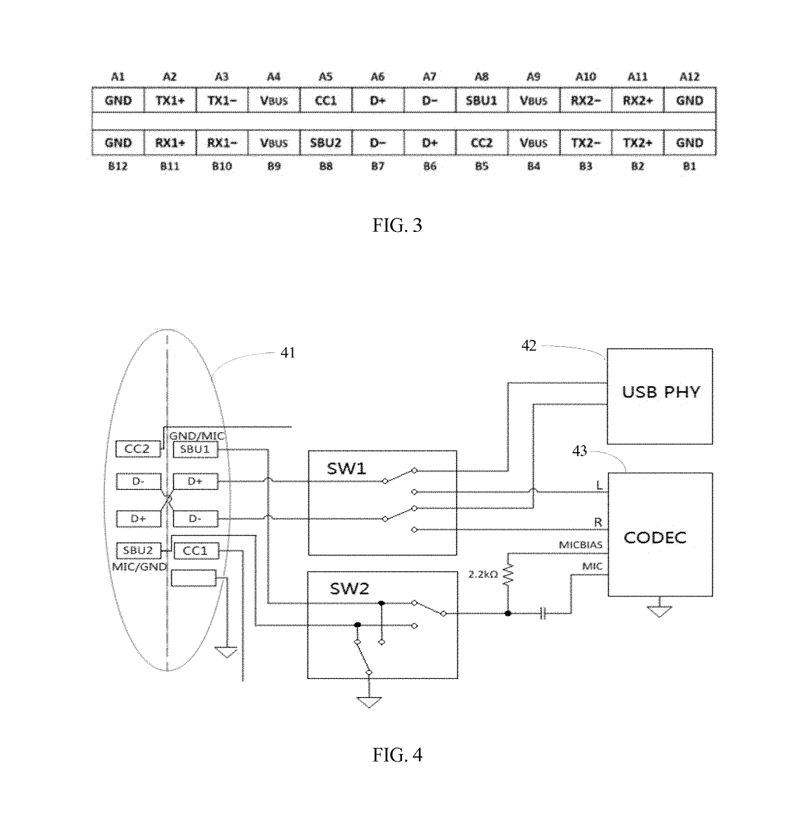

USB Developer Forum (USB-IF) issued Universal Serial Bus Type-C Cable and Connector Specification (version 1.0) on 11 Aug. 2014 and defined 24 pins and allocation thereof of a Type-C socket interface. FIG. 3 shows an allocating schematic view of the socket pins in accordance with the USB Type-C specification in the form of a front view. Table 1 shows identifications, names and descriptions of the 24 pins.

TABLE 1

| Identifications | Names | Descriptions |
|---|---|---|
| A1 | GND | Grounding |
| A2 | TX1+ | A pair of |
| A3 | TX1− | differential |
| | | signals |
| A4 | V_{BUS} | Power |
| | | supplies |
| A5 | CC1 | Configuration |
| | | channel |
| | | signals |
| A6 | D+ | A pair of |
| A7 | D− | differential |
| | | signals |
| A8 | SBU1 | Side band use |
| A9 | V_{BUS} | Power |
| | | supplies |
| A10 | RX2− | A pair of |
| A11 | RX2+ | differential |
| | | signals |
| A12 | GND | Grounding |
| B1 | GND | Grounding |
| B2 | TX2+ | A pair of |
| B3 | TX2− | differential |
| | | signals |
| B4 | V_{Bus} | Power |
| | | supplies |
| B5 | CC2 | Configuration |
| | | channel |
| | | signals |
| B6 | D+ | A pair of |
| B7 | D− | differential |
| | | signals |
| B8 | SBU2 | Side band use |
| B9 | V_{BUS} | Power |
| | | supplies |
| B10 | RX1− | A pair of |
| B11 | RX1+ | differential |
| | | signals |
| B12 | GND | Grounding |

According to the USB Type-C specification, CC1 and CC2 are two key pins and have many functions, such as detecting connection, front and back face distinguishing, VBUS pin configuration, configuration of other modes (for example, audio accessory connection and PCIE) and the like. Two groups of TX/RX differential signal pairs are used for a data transmission of a USB3.1 standard, and D+/D− differential signal pairs are used for being compatible with a data transmission of a USB2.0 standard. SBU1 and SBU2 pins are the reserved pins conforming to the Type-C specification and used for extension function. The USB Type-C interface further includes four grounding pins and four power supply pins.

FIG. 4 shows a principle schematic view of the user equipment (for example, a smart phone) in accordance with one embodiment of the disclosure. 1. The user equipment, including: a USB Type-C interface 41, a USB physical layer (USB PHY) 42, an audio codec (CODEC) 43, a first analog switch device SW1 and a second analog switch device SW2. As shown in the figures, a left channel terminal L and a right channel terminal R of the audio codec (CODEC) and the data transmission terminal of the USB physical layer (USB PHY) multiplex D+ and D− pins of the USB Type-C interface. In addition, the reserved SBU1 and SBU2 pins conforming to the USB Type-C specification are used for transmission of MIC signals of the audio codec.

The first analog switch device SW1 is configured to, when detecting that an analog audio cable is inserted into the USB Type-C interface 41, switch the D+ and D− pins of the USB Type-C interface to connect with the left channel terminal L and the right channel terminal R of the audio codec 43 respectively. The first analog switch device SW1 is further configured to, when detecting that a USB cable is inserted into the USB Type-C interface, switch the D+ and D− pins of the USB Type-C interface to connect with the data transmission terminal of the USB physical layer 42 respectively.

The second analog switch device SW2 is configured to achieve a microphone data transmission of the audio codec 43 by utilizing the SBU1 pin or the SBU2 pin of the USB Type-C interface 41. As shown in the FIG. 4, when the SBU1 is used for being connected with an analog audio peripheral, for example, an MIC connecting line of a headphone, the SW2 is configured to switch the SBU1 to connect with the MIC terminal of the CODEC 43, and meanwhile the SBU2 can serve as an audio equipment ground of the analog audio peripheral; and vice versa.

As shown in the FIG. 4, the D+ pin is used for being connected with the left channel terminal L of the CODEC 43, and the D− pin is used for being connected with the right channel terminal R of the CODEC. However, it should be understood that the wordings “left” and “right” are opposite concepts, and in the concrete implementation, the D− pin can also be used for being connected with the left channel terminal L of the CODEC, and the D+ pin can also be used for being connected with the right channel terminal R of the CODEC.

According to the embodiment of the disclosure, the type of the cable inserted into the USB Type-C interface can be judged by judging the using states of other pins except the above-mentioned pins (D+, D−, SBU1 and SBU2) in the USB Type-C interface 41.

In one embodiment, when the plugged cable is the analog audio cable, many pins except the above-mentioned pins in the USB Type-C interface 41 are all in a “suspended” high-resistance-value state. As an example, the type of the cable inserted into the USB Type-C interface, namely the USB Type-C cable or the analog audio cable, can be judged by detecting the resistance values of the CC1 and/or CC2 pins of the USB Type-C interface.

In another embodiment, an analog audio cable interface used for being matched with the USB Type-C interface 41 of the user equipment can be configured so that the first analog switch device SW1 and/or the second analog switch device SW2 can detect the type of the plugged cable. For example, when the CC1 and CC2 pins and a GND pin of the USB Type-C interface of the user equipment are used, the GND pin is used for being connected with the GND of the analog audio cable interface, and the analog audio cable interface is configured to be provided with a resistor between the CC1 and CC2 of the USB Type-C interface of the user equipment and the GND inside the interface, and the resistance value of the resistor and resistance (generally 5.1 kΩ) of the CC1 and CC2 pins of the standard USB Type-C interface (for example a USB plug). Accordingly, the SW1 can judge the type of the cable inserted into the USB Type-C interface (for example, a USB socket) by detecting the resistance between the CC1 and CC2 pins and the GND. For example, the SW can be configured to determine that the analog audio cable is inserted into the USB Type-C interface, when detecting the resistance value between the CC1 pin and the GND pin of the USB Type-C interface and the resistance value between the CC2 pin and the GND pin of the USB Type-C interface are both less than 1 kΩ.

According to the embodiment of the disclosure, the reserved SBU1 and SBU2 pins conforming to the Type-C specification are used for transmission of the MIC signals of the audio codec. However, it should be understood that the second analog switch device SW2 shown in the FIG. 4 is an optional component, for example, SW2 configuration is not necessary under the situation that the analog audio cable inserted into the USB Type-C interface 41 does not support a microphone (MIC) or the CODEC inside the user equipment does not support the MIC.

In one embodiment, the MIC connecting line of the analog audio cable interface matched with the SBU1 or the SBU2 of the USB Type-C interface 41 of the user equipment can be configured so that the second analog switch device SW2 can detect whether the plugged analog audio cable supports the MIC or not. For example, whether the MIC connecting line of the analog audio cable interface is connected or not can be judged by detecting whether the SBU1 or the SBU2 pin is in an unconnected “suspended” state or not. As an example, if it is detected that the SBU1 pin is in a used state while the SBU2 pin is still in the unused “suspended” state, the SW2 can switch the SBU1 pin to be connected with the MIC terminal of the CODEC so as to switch the SBU1 pin to be connected with a grounding point. For example, the “suspended” state of the SBU1 or the SBU2 pin can be obtained by detecting the resistance value between the pin and the grounding point.

Alternatively, a resistance value between the MIC connecting line of the analog audio cable interface configured to be matched with the SBU1 or the SBU2 of the USB Type-C interface 41 of the user equipment and the ground point may be configured to be in a specified range, and then, a pin that supports MIC signal transmission may be detected by detecting whether the resistance value between the SBU1 or the SBU2 of the USB Type-C interface of the user equipment and the ground point is in the specified range.

According to an embodiment of the disclosure, the USB Type-C interface of the user equipment may be directly utilized to achieve the analog audio transmission function, so as to omit the traditional analog audio outlet, for example, a 3.5 mm audio outlet. If the user equipment is a cell phone, the cell phone may be designed to have no headphone socket, which makes the cell phone thinner. Also, the area occupied by the printed circuit board is reduced to achieve more functions. For example, the clearance space of a cell phone antenna may be increased to improve the cell phone signals, or the battery space of the cell phone may be increased to extend the standby time of the cell phone and the like.

It should be understood that the user equipment described in the embodiments of the disclosure can be a smart phone, a portable computer, a tablet computer, a desktop computer or other suitable user equipments having a USB Type-C interface for supporting an analog audio output.

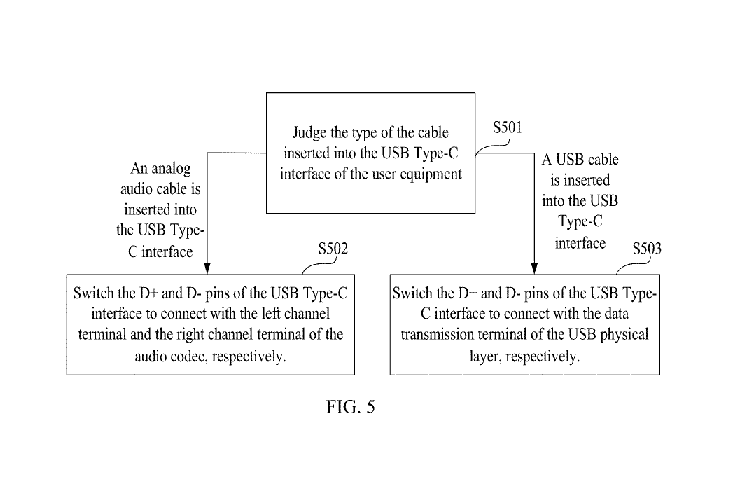

FIG. 5 shows a diagram of the method for data transmission in accordance with one embodiment of the disclosure, and the method which is applied to the user equipment includes the following steps: in step S501, judge the type of the cable inserted into the USB Type-C interface of the user equipment, when detecting that an analog audio cable is inserted into the USB Type-C interface, perform the step S502, switch the D+ and D− pins of the USB Type-C interface to connect with the left channel terminal and the right channel terminal of the audio codec respectively; and when detecting that a USB cable is inserted into the USB Type-C interface, perform the step S503, switch the D+ and D− pins of the USB Type-C interface to connect with the data transmission terminal of the USB physical layer respectively.

wherein the USB Type-C interface is compatible with USB signal delivery and analog audio peripherals; the USB physical layer is connected with the USB Type-C interface to realize the transmission of a USB signal; the audio codec is connected with the USB Type-C interface to realize the transmission of an analog audio.

Wherein judging the type of the cable inserted into the USB Type-C interface of the user equipment, includes: judge the type of the cable inserted into the USB Type-C interface by detecting a resistance value of a CC1 pin and/or CC2 pin of the USB Type-C interface.

wherein judging the type of the cable inserted into the USB Type-C interface of the user equipment, includes: determine that an analog audio cable is inserted into the USB Type-C interface, when detecting that the resistance value between the CC1 pin and a GND pin of the USB Type-C interface and the resistance value between the CC2 pin and the GND pin of the USB Type-C interface are both less than 1 MΩ.

In one embodiment, the method further includes: achieve the microphone data transmission of the audio codec by utilizing a SBU1 pin or a SBU2 pin of the USB Type-C interface.

In one embodiment, the method further includes: judge whether the analog audio cable inserted into the USB Type-C interface supports a microphone by detecting the resistance value of the SBU1 pin or the SBU2 pin of the USB Type-C interface.

Wherein the user equipment described in the embodiments of the disclosure can be a smart phone, a portable computer, a tablet computer, a desktop computer or other suitable user equipments having a USB Type-C interface for supporting an analog audio output.

According to an embodiment of the disclosure, the USB Type-C interface of the user equipment may be directly utilized to achieve the analog audio transmission function, so as to omit the traditional analog audio outlet. If the user equipment is a cell phone, the cell phone may be designed to have no headphone socket, which makes the cell phone thinner. Also, the area occupied by the printed circuit board is reduced to achieve more functions.

It shall be noted that the above embodiments are disclosed to explain technical solutions of the present disclosure, but not for limiting purposes. While the present disclosure has been described in detail with reference to the above embodiments, those skilled in this art shall understand that the technical solutions in the above embodiments can be modified, or a part of technical features can be equivalently substituted, and such modifications or substitutions will not make the essence of the technical solutions depart from the spirit or scope of the technical solutions of various embodiments in the present disclosure.

1-6. (canceled)

7. A user equipment, comprising:
a USB Type-C interface, which is compatible with USB signal delivery and analog audio peripherals;
a USB physical layer, which is configured to connect with the USB Type-C interface to realize the transmission of a USB signal;
an audio codec, which is configured to connect with the USB Type-C interface to realize the transmission of an analog audio, wherein a left channel terminal and a right channel terminal of the audio codec and a data transmission terminal of the USB physical layer D+ and D− pins of the USB Type-C interface; and
a first analog switch device, which is configured to implement the multiplexing, wherein the first analog switch device is configured to, when detecting that an analog audio cable is inserted into the USB Type-C interface, switch the D+ and D− pins of the USB Type-C interface to connect the left channel terminal and the right channel terminal of the audio codec respectively, and when detecting that a USB cable is inserted into the USB Type-C interface, switch the D+ and D− pins of the USB Type-C interface to connect the data transmission terminal of the USB physical layer respectively.

8. The user equipment according to claim 7, wherein the first analog switch device is configured to judge the type of a cable inserted into the USB Type-C interface by detecting a resistance value of a CC1 pin and/or CC2 pin of the USB Type-C interface.

9. The user equipment according to claim 7, wherein the first analog switch device is configured to determine that an analog audio cable is inserted into the USB Type-C interface when detecting that both the resistance value between the CC1 pin and a GND pin of the USB Type-C interface and the resistance value between the CC2 pin and the GND pin of the USB Type-C interface are less than 1 kΩ.

10. The user equipment according to claim 7, further comprising:
a second analog switch device configured to realize the transmission of microphone data of the audio codec by using a SBU1 pin or a SBU2 pin of the USB Type-C interface.

11. The user equipment according to claim 10, wherein the second analog switch device is configured to judge whether an analog audio cable inserted into the USB Type-C interface supports a microphone by detecting a resistance value of the SBU1 pin or the SBU2 pin of the USB Type-C interface.

12. The user equipment according to claim 7, wherein the user equipment is a smart phone, a portable computer, a tablet computer or a desktop computer.

13. A method for data transmission, which is applied to user equipment, the method comprising:
judging the type of the cable inserted into the USB Type-C interface of the user equipment;
when detecting that an analog audio cable is inserted into the USB Type-C interface, switching the D+ and D− pins of the USB Type-C interface to connect with the left channel terminal and the right channel terminal of the audio codec respectively, and when detecting that a USB cable is inserted into the USB Type-C interface, switching the D+ and D− pins of the USB Type-C interface to connect with the data transmission terminal of the USB physical layer respectively; wherein the USB Type-C interface is compatible with USB signal delivery and analog audio peripherals;
the USB physical layer is connected with the USB Type-C interface to realize the transmission of a USB signal;
the audio codec is connected with the USB Type-C interface to realize the transmission of an analog audio.

14. The method according to claim 13, wherein judging the type of the cable inserted into the USB Type-C interface of the user equipment, further comprises: judge the type of the cable inserted into the USB Type-C interface by detecting a resistance value of a CC1 pin and/or CC2 pin of the USB Type-C interface.

15. The method according to claim 13, wherein judging the type of the cable inserted into the USB Type-C interface of the user equipment, comprises: determine that the analog audio cable is inserted into the USB Type-C interface, when detecting that the resistance value between the CC1 pin and a GND pin of the USB Type-C interface and the resistance value between the CC2 pin and the GND pin of the USB Type-C interface are both less than 1 kΩ.

16. The method according to claim 13, further comprising:
achieving the microphone data transmission of the audio codec by utilizing a SBU1 pin or a SBU2 pin of the USB Type-C interface.

17. The method according to claim 13, further comprising:
judging whether the analog audio cable inserted into the USB Type-C interface supports a microphone by detecting the resistance value of the SBU1 pin or the SBU2 pin of the USB Type-C interface.

18. The method according to claim 13, wherein the user equipment is a smart phone, a portable computer, a tablet computer or a desktop computer.
